(19) United States
(12) Patent Application Publication
(10) Pub. No.: US 2025/0179981 A1
(43) Pub. Date: Jun. 5, 2025

(54) METHOD FOR STARTING UP AN INTERNAL COMBUSTION ENGINE

(71) Applicant: Schaeffler Technologies AG & Co. KG, Herzogenaurach (DE)

(72) Inventors: Erhard Hodrus, Achern (DE); Alexander Rösch, Achern (DE)

(73) Assignee: Schaeffler Technologies AG & Co. KG, Herzogenaurach (DE)

(21) Appl. No.: 18/832,101

(22) PCT Filed: Feb. 1, 2023
(86) PCT No.: PCT/DE2023/100076

§ 371 Date: Jul. 23, 2024

(30) Foreign Application Priority Data
Feb. 4, 2022 (DE) 10 2022 102 634.5

(51) Int. Cl. F02N 11/08; B60K 6/26; B60W 20/00

(52) U.S. Cl. CPC F02N 11/0803; B60K 6/26; B60W 20/00; F02N 11/0859; B60K 2006/268; B60W 2510/0638; B60W 2510/081; F02N 2200/022; F02N 2200/041

(57) ABSTRACT

A method is provided for starting up an internal combustion engine in a drive train using a torque of a multi-pole electric motor which is torque-transmittingly connected to the internal combustion engine, encoderlessly operated and has a rotor that can be rotated relative to a stator and to which a co-rotating QD-coordinate system is assigned. A rotor rotational speed of the rotor is increased from a resting rotor and, during this starting process of the rotor, in the D-direction, a first excitation voltage is applied at the electric motor, which is greater than a comparison excitation voltage by an electrical additional voltage, which is applied under the same conditions at the electric motor during a starting process of the electric motor omitting a starting-up of the internal combustion engine.

### CROSS-REFERENCE TO RELATED APPLICATIONS

This application is the U.S. National Phase of PCT Appln. No. PCT/DE2023/100076 filed Feb. 1, 2023, which claims priority to DE 10 2022 102 634.5 filed Feb. 4, 2022, the entire disclosures of which are incorporated by reference herein.

### TECHNICAL FIELD

The disclosure relates to a method for starting up an internal combustion engine of a drive train.

### BACKGROUND

WO 2020 001 681 A1 describes a torque transmission device which has an electric motor with a stator and a rotor which can be rotated relative to the stator and a control system which can output a current pulse to the electric motor, wherein the current pulse causes a rotational movement of the rotor in a first direction of rotation and by a first angle of rotation and thereby induces an induced voltage which is received by the control system and by which the control system determines the direction of rotation and/or the rotational position of the rotor with respect to the stator.

DE 10 2018 120 421 A1 discloses a method for encoderless control of permanently magnetically excited, synchronous electric motors, in which a system is described in a stationary αβ-coordinate system of an electric motor. The system comprises an electromagnetic model and a mechanical model of an electric motor with drive train. For the model, differential inductances, each of which depends on the currents of the electric motor, are stored in the form of look-up tables. The look-up tables can be retrieved for calculation. Based on the electromagnetic and mechanical model, the speed and angle of the electric motor are estimated by a Kalman filter, mainly via the mechanical model. The electrical model can be used to provide an internal torque for the torque equation in order to determine a change in speed or angle.

### SUMMARY

The object of the present disclosure is to start up the internal combustion engine more reliably and in a more energy-efficient manner. The electric motor should be constructed and operated in a cost-effective and space-saving manner.

At least one of these objects is achieved by a method for starting up an internal combustion engine having the features according to the claims and described herein. This allows the starting process to be carried out reliably at least until a predetermined speed threshold of the rotor rotational speed is reached. This allows the internal combustion engine to be started up reliably. The use of injection signals during the start-up process of the rotor to determine the rotational position of the rotor and/or the rotor rotational speed may be omitted.

The drive train can be arranged in a vehicle. The vehicle can be a motor vehicle.

The electric motor is encoderlessly operated, at least during the start up process. The electric motor can be encoderlessly operated permanently. Encoderless operation is understood to mean operation without taking into account a rotor position measured with a sensor, for example a position sensor.

The electric motor can be controlled via at least three motor phases.

In a preferred embodiment of the disclosure, it is advantageous if the additional voltage is set during the starting process independently of the rotor rotational speed. The voltage level of the additional voltage can be stored in a memory for retrieval. The amount of additional voltage can be adjusted depending on the temperature. The relationship between the amount of additional voltage and the temperature can be stored in a lookup table for retrieval.

In a special embodiment of the disclosure, it is advantageous if an amount of the additional voltage is set depending on the rotor rotational speed. The relationship between the amount of additional voltage and the rotor rotational speed can be stored in a lookup table for retrieval.

In an advantageous embodiment of the disclosure, it is provided that the additional voltage is discontinued when a speed threshold of the rotor rotational speed is reached. The additional voltage is set to zero when the speed threshold is reached.

In a special embodiment of the disclosure, it is advantageous if the electric motor is operated by a regulation mode at rotor rotational speeds greater than the speed threshold. The regulation mode of the encoderless electric motor can preferably have a field-oriented regulation.

In a preferred embodiment of the disclosure, it is provided that the starting process is preceded by an angle detection step in which a rotational position of the rotor is detected with respect to the stator. This prevents the rotor from rotating in an undesirable direction. The angle detection step may be omitted depending on the number of pole pairs of the electric motor. The larger the number of pole pairs, the smaller the misrotation of the rotor.

In a particular embodiment of the disclosure, it is advantageous if the angle detection step is carried out by applying an alternating voltage in an assumed d-direction, then the current response thereto is detected in the dq-coordinate system, by generating a first current response in relation to a first direction, which is offset by a difference angle with respect to the assumed d direction in the dq-coordinate system with a second current response with respect to a second direction, which is offset by the difference angle with respect to the assumed d-direction in the dq-coordinate system opposite to the first direction, and the assumed d-direction is approximated to the actual d-direction depending on this comparison. The difference angle can be 45°, whereby the first direction is offset by 90° from the second direction.

In an advantageous embodiment of the disclosure, it is provided that the rotor rotational speed is detected at least during the starting up of the internal combustion engine by a comparison with an engine speed of the internal combustion engine. This allows reliable detection when the speed threshold is reached.

In a special embodiment of the disclosure, it is advantageous if the drive train is a hybrid drive train in which the electric motor provides a drive torque in addition to the internal combustion engine. In a generator mode, the electric motor can generate electrical energy from the drive power of the internal combustion engine and/or the kinetic energy of the vehicle.

In a preferred embodiment of the disclosure, the hybrid drive train has a P1-hybrid structure in which the electric motor is directly connected to the internal combustion engine. The electric motor can be effectively arranged between the internal combustion engine and a transmission, preferably in front of a separating clutch.

Further advantages and advantageous embodiments of the disclosure result from the description of the figures and the drawings.

### BRIEF DESCRIPTION OF THE DRAWINGS

The disclosure is described in detail below with reference to the drawings. In the figures:

FIG. 1: shows a method for starting up an internal combustion engine in a particular embodiment of the disclosure.

FIG. 2: shows a temporal progression of a rotor rotational speed of the electric motor when carrying out the method of FIG. 1.

FIG. 3: a drive train for applying the method in a particular embodiment of the disclosure.

### DETAILED DESCRIPTION

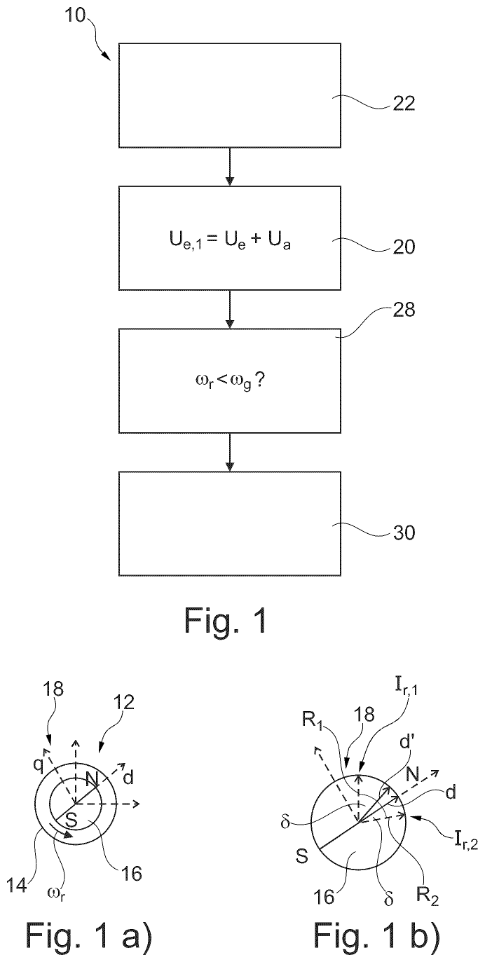

FIG. 1 shows a method for starting up an internal combustion engine in a particular embodiment of the disclosure. The method 10 is used for starting up an internal combustion engine. The internal combustion engine operates in a drive train that is designed as a hybrid drive train. The hybrid drive train includes an electric motor 12 and has a Pl-hybrid structure in which the electric motor 12 is directly connected to the internal combustion engine. The electric motor 12 provides a drive torque in addition to the internal combustion engine as required.

The internal combustion engine is started up by a torque provided by the electric motor 12. For this purpose, the electric motor 12 is torque-transmittingly connected to the internal combustion engine. The electric motor 12 is encoderlessly controlled and operated, i.e. without taking into account a rotor position measured with a sensor, for example a position sensor. As shown in FIG. 1 a), the electric motor 12 comprises a rotor 16 which is rotatable relative to a stator 14 and to which a co-rotating qd-coordinate system 18 is assigned.

The internal combustion engine is started up by the torque of the electric motor 12, wherein a rotor rotational speed ωᵣ of the rotor 16 is increased from a resting rotor 16 and, during this starting process 20 of the rotor 16, in the D-direction d, a first excitation voltage U_{e,1} is applied at the electric motor 12, which is greater than a comparison excitation voltage Uₑ by an electrical additional voltage Uₐ, which is applied under the same conditions at the electric motor 12 during a starting process of the electric motor 12 omitting a starting-up of the internal combustion engine 36.

The starting process 20 is preceded by an angle detection step 22 in which a rotational position of the rotor 16 is detected with respect to the stator 14. The angle detection step 22 is preferably carried out, as shown in FIG. 1 b), by applying an alternating voltage in an assumed d-direction d′, then the current response thereto is detected in the dq-coordinate system 18, by generating a first current response I_{r,1} in relation to a first direction R₁, which is offset by a difference angle δ of preferably 45° with respect to the assumed d direction d′ in the dq-coordinate system 18 with a second current response I_{r,2} with respect to a second direction R₂, which is offset by the difference angle δ with respect to the assumed d-direction d′ in the dq-coordinate system 18 opposite to the first direction R₁, and the assumed d-direction d′ is approximated to the actual d-direction d depending on this comparison. As a result, the rotary position of the rotor 16 can be ascertained more accurately and reliably with respect to that stator.

During the starting process 20, the additional voltage Uₐ applied in the d direction d of the excitation voltage is preferably set independently of the rotor rotational speed Ωᵣ. However, a speed check step 28 checks whether a speed threshold Ω_{g} of the rotor rotational speed Ωᵣ is reached and as soon as the speed threshold Ω_{g} is reached, the additional voltage Uₐ is set to zero and the electric motor 12 is operated at rotor rotational speeds Ωᵣ greater than the speed threshold Ω_{g} by a regulation mode 30. The regulation mode 30 comprises a field-oriented regulation for controlling the electric motor 12.

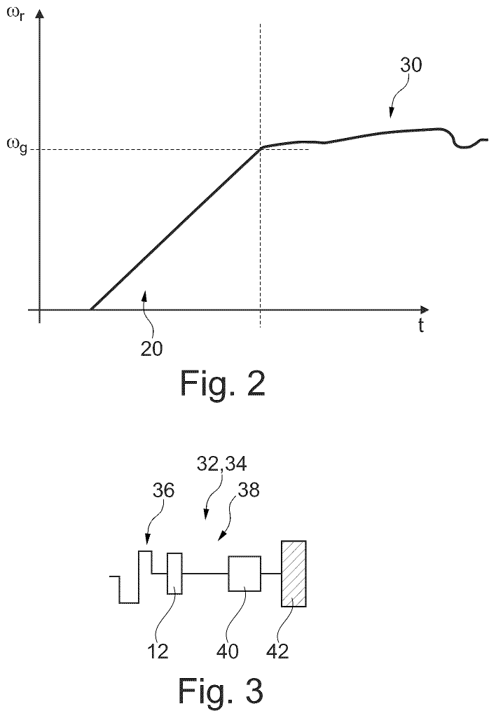

FIG. 2 shows a temporal progression of a rotor rotational speed Ωᵣ of the electric motor when carrying out the method of FIG. 1. The rotor rotational speed Ωᵣ is continuously increased during the starting process 20 by the additional voltage applied and when the speed threshold Ω_{g} is reached, the regulation mode 30 is set.

FIG. 3 shows a drive train for applying the method in a particular embodiment of the disclosure. The drive train 32 is arranged in a vehicle and designed as a hybrid drive train 34 in which the electric motor 12 provides a drive torque in addition to the internal combustion engine 36. The hybrid drive train 34 comprises a P1-hybrid structure 38 in which the electric motor 12 is directly connected to the internal combustion engine 36. In particular, a transmission 40 is connected downstream of the electric motor 12, which is connected on the output side to at least one vehicle wheel 42.

### LIST OF REFERENCE SIGNS

10 Method
12 Electric motor
14 Stator
16 Rotor
18 Coordinate system
20 Starting process
22 Angle detection step
28 Speed check step
30 Regulation mode
32 Drive train
34 Hybrid drive train
36 Internal combustion engine
38 P1-hybrid structure
40 Transmission
42 Vehicle wheel
d d-direction
d′ Assumed d-direction
I_{r,1} First current response
I_{r,2} Second current response
R₁ First direction
R₂ Second direction
Uₐ Additional voltage
Uₑ Comparison excitation voltage
U_{e,1} First excitation voltage
δ Difference angle
Ω_{g} Speed threshold
Ωᵣ Rotor rotational speed

1. A method for starting up an internal combustion engine in a drive train comprising: using a torque of a multi-pole electric motor which is torque-transmittingly connected to the internal combustion engine, encoderlessly operated and has a rotor that can be rotated relative to a stator and to which a co-rotating qd-coordinate system is assigned, wherein a rotor rotational speed of the rotor is increased from a resting rotor and, during this starting process of the rotor, in the a D-direction, a first excitation voltage is applied at the electric motor, which is greater than a comparison excitation voltage by an electrical additional voltage which is applied under the same conditions at the electric motor during a starting process of the electric motor omitting a starting-up of the internal combustion engine.

2. The method for starting up an internal combustion engine according to claim 1, wherein the additional voltage is set during the starting process regardless of the rotor rotational speed.

3. The method for starting up an internal combustion engine according to claim 1, wherein an amount of the additional voltage is set depending on the rotor rotational speed.

4. The method for starting up an internal combustion engine according to claim 1, wherein the additional voltage is discontinued when a speed threshold of the rotor rotational speed is reached.

5. The method for starting up an internal combustion engine according to claim 4, wherein the electric motor is operated at rotor rotational speeds greater than the speed threshold by a regulation mode.

6. The method for starting up an internal combustion engine according to claim 1, wherein the starting process is preceded by an angle detection step in which a rotational position of the rotor is detected with respect to the stator.

7. The method for starting up an internal combustion engine according to claim 6, wherein in the angle detection step is carried out by applying an alternating voltage in an assumed d-direction, then a current response thereto is detected in a dq-coordinate system, by generating a first current response relation to a first direction, which is offset by a difference angle with respect to the assumed d direction in the dq-coordinate system with a second current response with respect to a second direction, which is offset by the difference angle with respect to the assumed d-direction in the dq-coordinate system opposite to the first direction and compared, and the assumed d-direction is approximated to the actual d-direction depending on this comparison.

8. The method for starting up an internal combustion engine according to claim 1, wherein rotor rotational speed is detected at least during the starting up of the internal combustion engine by a comparison with an engine speed of the internal combustion engine.

9. The method for starting up an internal combustion engine according to claim 1, wherein the drive train is a hybrid drive train in which the electric motor provides a drive torque in addition to the internal combustion engine.

10. The method for starting up an internal combustion engine according to claim 9, wherein the hybrid drive train has a P1-hybrid structure in which the electric motor this is directly connected to the internal combustion engine.
